(19) United States
(12) Patent Application Publication
(10) Pub. No.: US 2024/0397600 A1
(43) Pub. Date: Nov. 28, 2024

(54) ILLUMINATION DEVICE

(71) Applicant: Japan Display Inc., Tokyo (JP)

(72) Inventor: Hiroyuki WAKANA, Tokyo (JP)

(21) Appl. No.: 18/798,175

(22) Filed: Aug. 8, 2024

Related U.S. Application Data
(63) Continuation of application No. PCT/JP2023/002230, filed on Jan. 25, 2023.

(30) Foreign Application Priority Data
Feb. 21, 2022 (JP) 2022-024833

(51) Int. Cl. H05B 47/16; F21S 8/04; G02F 1/1333; H05B 47/155; H05B 47/165

(52) U.S. Cl. CPC H05B 47/16; F21S 8/04; G02F 1/133368; H05B 47/155; H05B 47/165

(57) ABSTRACT

An illumination device includes a light source part configured to emit light to a floor surface of a room, a light distribution area setter configured to set a light distribution area of light from the light source part to a first light distribution area or a second light distribution area different from the first light distribution area, and a controller configured to control the light distribution area setter so that light is emitted to the first light distribution area and the second light distribution area in a time-division manner. The second light distribution area set by the light distribution area setter includes a part closer to a corner of the floor surface than the first light distribution area.

### CROSS-REFERENCE TO RELATED APPLICATION

This application is a continuation of International Patent Application No. PCT/JP2023/002230 filed on Jan. 25, 2023 which designates the United States, incorporated herein by reference, and which claims the benefit of priority from Japanese Patent Application No. 2022-024833 filed on Feb. 21, 2022, incorporated herein by reference.

### BACKGROUND

### 1. Technical Field

The present disclosure relates to an illumination device.

### 2. Description of the Related Art

Japanese Patent Application Laid-open Publication No. H02-065001 (JP-A-H02-065001) discloses an illumination instrument including a liquid crystal light adjustment element. In the illumination instrument disclosed in JP-A-H02-065001, light adjustment is performed by providing an electric signal to the liquid crystal light adjustment element.

In the illumination instrument disclosed in JP-A-JP-A-H02-065001, light adjustment can be performed by changing a setting value of the electric signal provided to the liquid crystal light adjustment element. However, it is difficult to emit light to a whole room. In particular, it is difficult to emit light to positions far away from directly below an illumination device, such as the four corners of a room.

The present disclosure is made in view of the above-described problem and intended to provide an illumination device capable of emitting light to positions far away from directly below an illumination device, such as the four corners of a room.

### SUMMARY

An illumination device according to an embodiment of the present disclosure includes a light source part configured to emit light to a floor surface of a room, a light distribution area setter configured to set a light distribution area of light from the light source part to a first light distribution area or a second light distribution area different from the first light distribution area, and a controller configured to control the light distribution area setter so that light is emitted to the first light distribution area and the second light distribution area in a time-division manner. The second light distribution area set by the light distribution area setter includes a part closer to a corner of the floor surface than the first light distribution area.

### BRIEF DESCRIPTION OF THE DRAWINGS

FIG. 1 is a diagram illustrating an example of the irradiation areas of illumination devices in a comparative example;

FIG. 2 is a diagram illustrating an example of the irradiation areas of illumination devices in another comparative example;

FIG. 3 is a diagram illustrating a functional configuration of an illumination device according to a first embodiment of the present disclosure;

FIG. 4 is a conceptual diagram illustrating an example of storage contents of a first storage;

FIG. 5 is a conceptual diagram illustrating a first example of storage contents of a second storage;

FIG. 6 is a conceptual diagram illustrating a second example of storage contents of the second storage;

FIG. 7 is a conceptual diagram illustrating a third example of storage contents of the second storage;

FIG. 8 is a diagram illustrating an example of setting light distribution areas similar to each other in shape with different sizes;

FIG. 9 is a plan view illustrating an example of light distribution areas on a floor surface in FIG. 8;

FIG. 10 is a diagram illustrating exemplary switching of light distribution areas by the illumination device in FIGS. 8 and 9;

FIG. 11 is a diagram illustrating an example of setting light distribution areas in different shapes;

FIG. 12 is a plan view illustrating an example of light distribution areas on a floor surface in FIG. 11;

FIG. 13 is a diagram illustrating exemplary switching of light distribution areas for achieving the light distribution areas illustrated in FIGS. 11 and 12;

FIG. 14 is a plan view illustrating another example of light distribution areas on a floor surface in FIG. 11;

FIG. 15 is a diagram illustrating exemplary switching of light distribution areas for achieving the light distribution areas illustrated in FIG. 14;

FIG. 16 is a diagram illustrating a functional configuration of an illumination device according to a second embodiment of the present disclosure;

FIG. 17 is a diagram illustrating switching of light distribution areas according to the second embodiment;

FIG. 18 is a diagram illustrating switching of light distribution areas according to the second embodiment;

FIG. 19 is a diagram illustrating switching of light distribution areas according to a third embodiment;

FIG. 20 is a diagram illustrating switching of light distribution areas according to the third embodiment;

FIG. 21 is a diagram illustrating switching of light distribution areas according to a fourth embodiment;

FIG. 22 is a diagram illustrating switching of light distribution areas according to a fifth embodiment;

FIG. 23 is a diagram illustrating an example of storage contents of a storage in a case where different times are set to light distribution areas;

FIG. 24 is a diagram illustrating an example of storage contents of the storage in a case where different times are set to light distribution areas;

FIG. 25 is a diagram illustrating an example of storage contents of the storage in a case where different times are set to light distribution areas;

FIG. 26 is a flowchart illustrating an example of processing by a controller of an illumination device;

FIG. 27 is a perspective view of a liquid crystal light distribution panel according to an embodiment;

FIG. 28 is a plan view illustrating wiring of an array substrate of the liquid crystal light distribution panel according to the embodiment;

FIG. 29 is a plan view illustrating wiring of a counter substrate of the liquid crystal light distribution panel according to the embodiment;

FIG. 30 is a plan view illustrating wiring of the liquid crystal light distribution panel according to the embodiment;

FIG. 31 is a sectional view along line IV-IV in FIG. 30;

FIG. 32 is a schematic diagram illustrating the configuration of a liquid crystal light distribution part; and

FIG. 33 is a schematic diagram illustrating an example of light distribution control by a light distribution control region.

### DETAILED DESCRIPTION

Aspects (embodiments) of the present disclosure will be described below in detail with reference to the accompanying drawings. Contents described below in the embodiments do not limit the present disclosure. Components described below include those that could be easily thought of by the skilled person in the art and those identical in effect. Components described below may be combined as appropriate. What is disclosed herein is merely exemplary, and any modification that could be easily thought of by the skilled person in the art as appropriate without departing from the gist of the disclosure is contained in the scope of the present disclosure. For clearer description, the drawings are schematically illustrated for the width, thickness, shape, and the like of each component as compared to an actual aspect in some cases, but the drawings are merely exemplary and do not limit interpretation of the present disclosure. In the present specification and drawings, any element same as that already described with reference to an already described drawing is denoted by the same reference sign, and detailed description thereof is omitted as appropriate in some cases.

### Comparative Example

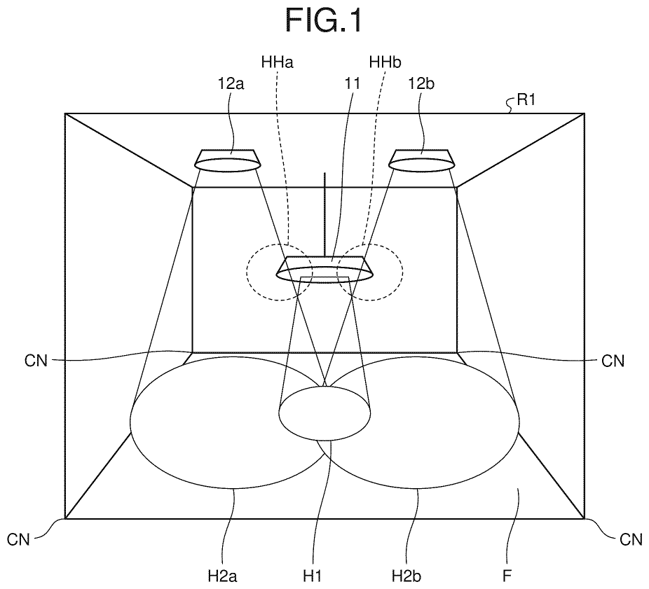

To facilitate understanding of the contents of the present disclosure, a comparative example will be described first. FIG. 1 is a diagram illustrating an example of the irradiation areas of illumination devices in the comparative example.

In FIG. 1, an illumination device 11 and illumination devices 12a and 12b are provided in a room R1. The illumination device 11 is suspended from the ceiling. The illumination devices 12a and 12b are directly attached to the ceiling. The illumination device 11, the illumination devices 12a and 12b emit light to a floor surface F. The illumination device 11 irradiates an irradiation area H1 with light. The illumination device 12a irradiates an irradiation area H2a with light. The illumination device 12b irradiates an irradiation area H2b with light.

With such irradiation areas H1, H2a, and H2b, light is not emitted to corners CN of the floor surface F of the room R1 and near the corners CN, which is not preferable. Furthermore, as illustrated in FIG. 1, shadows are cast by a part of the illumination device 11, which is illustrated with a dashed line HHa due to light from the illumination device 12a. In addition, shadows are cast by a part of the illumination device 11, which is illustrated with a dashed line HHb due to light from the illumination device 12b. In this manner, shadows are cast by the illumination device 11 in a case where the illumination device 11 suspended from the ceiling is used, which is not preferable.

The boundary of each light distribution area are clearly illustrated in FIG. 1. However, light from a light source includes light other than parallel light, and accordingly, the boundary of the light distribution area is blurred. This is the same for subsequent drawings.

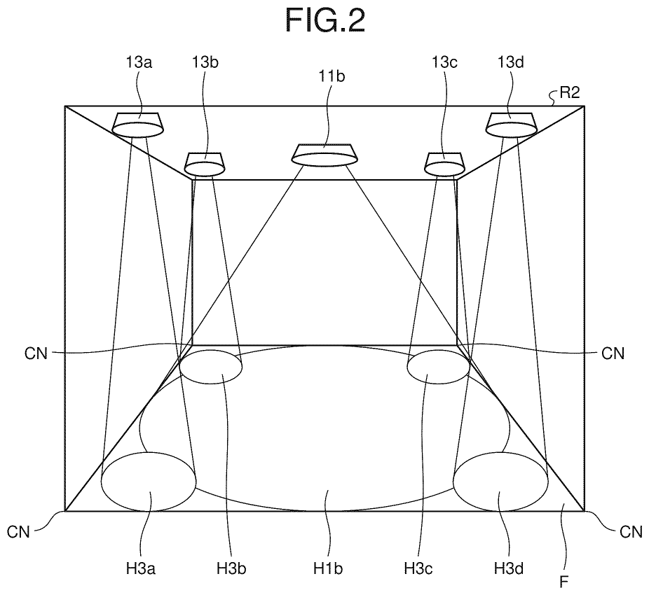

FIG. 2 is a diagram illustrating an example of the irradiation areas of illumination devices in another comparative example. In FIG. 2, an illumination device 11b and illumination devices 13a, 13b, 13c, and 13d are provided in a room R2. All illumination devices 11b, 13a, 13b, 13c, and 13d are directly attached to the ceiling.

The illumination device 11b irradiates an irradiation area H1b with light. The illumination device 13a irradiates an irradiation area H3a with light. The illumination device 13b irradiates an irradiation area H3b with light. The illumination device 13c irradiates an irradiation area H3c with light. The illumination device 13d irradiates an irradiation area H3d with light.

Unlike the case of FIG. 1, no illumination device suspended from the ceiling is installed in the room R2. Accordingly, no shadows are cast by an illumination device suspended from the ceiling. Light is emitted to corners CN of a floor surface F of the room R2 and near the corners CN. However, a plurality of illumination devices need to be provided to emit light to the four corners CN of the floor surface F and near the corners CN. In a case where a plurality of illumination devices are used, cost increases and spaces are needed for installation of the illumination devices, which is a problem. In a case of a typical existing house, wiring is provided only at one place on the ceiling of one room R2, and thus it is difficult to install a plurality of illumination devices. In a case of a recessed ceiling downlight, a plurality of holes need to be drilled through the ceiling, which is not preferable.

Unlike the above-described comparative examples, according to embodiments described below, light can be emitted to corners of the floor surface of a room and near the corners by installing one illumination device in one room.

### First Embodiment

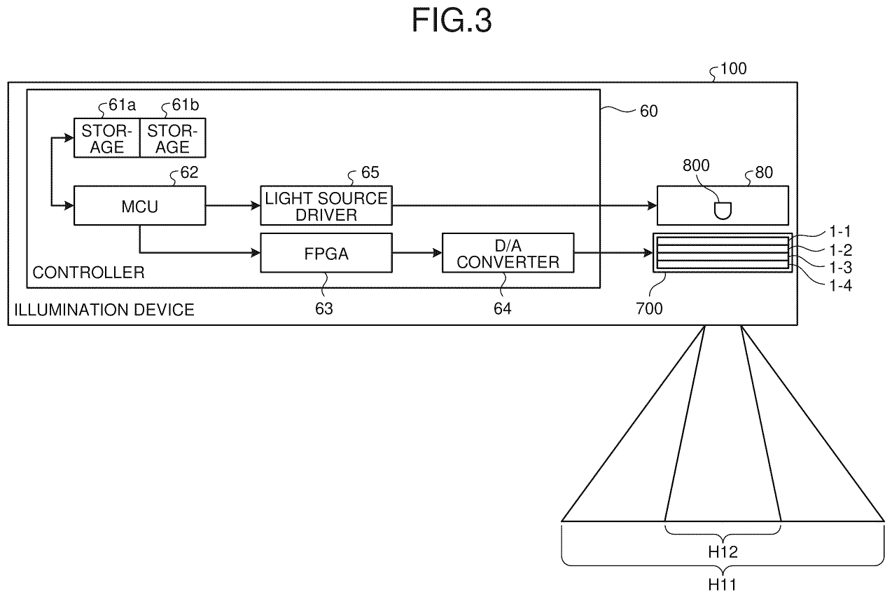

FIG. 3 is a diagram illustrating a functional configuration of an illumination device 100 according to a first embodiment of the present disclosure. In FIG. 3, the illumination device 100 includes a light source part 80, a liquid crystal light distribution part 700, and a controller 60. The light source part 80 includes a light source 800. The liquid crystal light distribution part 700 includes a plurality of liquid crystal light distribution panels 1-1 to 1-4.

The illumination device 100 is an illumination device provided to allow individual control of the irradiation area (light distribution area) of light from the light source 800 by using the liquid crystal light distribution part 700. The liquid crystal light distribution part 700 functions as a light distribution area setter configured to set the light distribution area. With the liquid crystal light distribution part 700, it is possible to achieve a light distribution area H11 on which light from the light source 800 is widely diffused and a light distribution area H12 on which light from the light source 800 is narrowly diffused. The liquid crystal light distribution part 700 includes a liquid crystal light distribution panel for p-wave polarization and a liquid crystal light distribution panel for s-wave polarization. A detailed configuration of the liquid crystal light distribution panels included in the liquid crystal light distribution part 700 will be described later.

The controller 60 includes storages 61a and 61b, a micro controller unit (MCU) 62, a field programmable gate array (FPGA) 63, a digital/analog (D/A) converter 64, and a light source driver 65.

The MCU 62 outputs various signals to the FPGA 63 and the light source driver 65 in accordance with a command related to operation of the illumination device 100. Accordingly, the MCU 62 controls components of the illumination device 100.

Under control by the MCU 62, the FPGA 63 performs information processing for controlling operation of the liquid crystal light distribution part 700 and outputs a signal indicating a result of the information processing to the D/A converter 64.

The D/A converter 64 outputs, based on a digital signal that is a signal from the FPGA 63, an analog signal for operating the liquid crystal light distribution panels 1-1 to 1-4 included in the liquid crystal light distribution part 700. The configuration may be one circuit or may include a plurality of circuits.

The light source driver 65 is a controller that performs, under control by the MCU 62, ON/OFF control of the light source 800 included in the light source part 80 and light emission intensity control when the light source 800 is ON. The controller may be one circuit or may include a plurality of circuits.

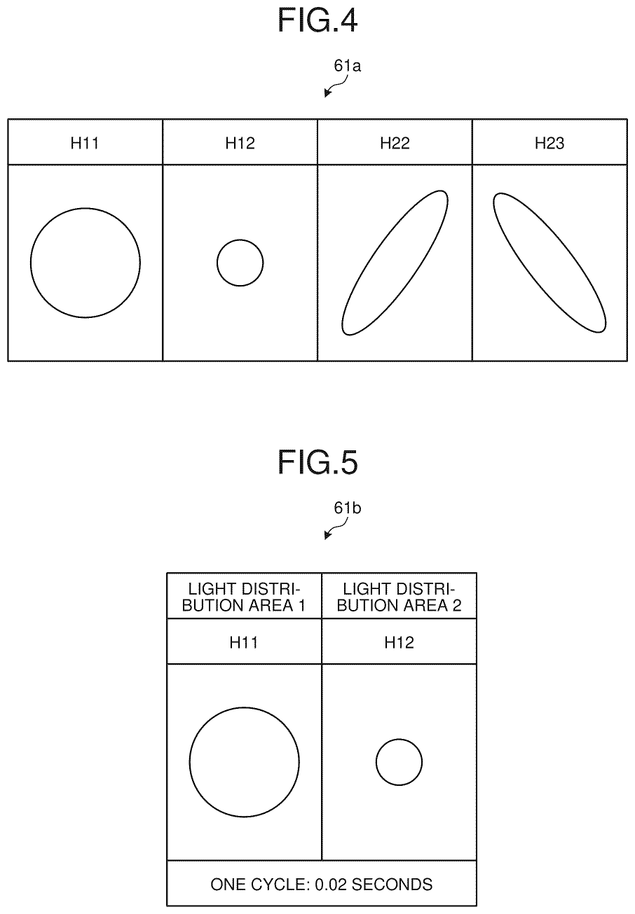

The storage 61a as a first storage stores data corresponding to a plurality of kinds of light distribution areas. FIG. 4 is a conceptual diagram illustrating an example of storage contents of the storage 61a. As illustrated in FIG. 4, the storage 61a stores, for example, data related to shape and size for light distribution areas H11, H12, H22, and H23. The storage 61b as a second storage stores light distribution areas determined by the MCU 62. In other words, the storage 61b stores a light distribution area pattern combining a plurality of kinds of light distribution areas.

FIG. 5 is a conceptual diagram illustrating a first example of storage contents of the storage 61b. As illustrated in FIG. 5, the storage 61b stores light distribution areas determined by the MCU 62 among the storage contents of the storage 61a. In the present example, the light distribution area H11 is stored as “light distribution area 1”, and the light distribution area H12 is stored as “light distribution area 2”. Accordingly, the storage 61b stores a light distribution area pattern combining a plurality of kinds of light distribution areas. In the present example, a light distribution area pattern combining the light distribution areas H11 and H12 is stored.

The light distribution areas H11 and H12 of a light distribution area pattern as a storage content of the storage 61b are sequentially read out by the MCU 62. The MCU 62 controls the liquid crystal light distribution part 700 based on the shapes and sizes of the light distribution areas H11 and H12 that have been read out. Specifically, the light distribution areas H11 and H12 are sequentially set to the liquid crystal light distribution part 700. To the liquid crystal light distribution part 700, the MCU 62 sets the light distribution area H11 as an initial value (N=1), sets the light distribution area H12 as an upper limit value (N=Nmax), and then sets the light distribution area H11 as the initial value. With setting in the same manner thereafter, the light distribution areas H11 and H12 are repeatedly set in a time-division manner. Accordingly, the liquid crystal light distribution part 700 as a light distribution area setter is controlled so that light is emitted to the light distribution areas H11 and H12 in a time-division manner.

As illustrated in FIG. 5, one cycle (hereinafter referred to as switching cycle) of time-division control is also stored in the storage 61b. The switching cycle is a time from the above-described initial value (N=1) to the above-described upper limit value (N=Nmax) for a light distribution area. In the present example, the switching cycle is “0.02 seconds”, corresponding to 50 Hz. The switching cycle may be set in advance or may be determined by the MCU 62 and stored in the storage 61b. This is the same for subsequent description. In the present example, the switching cycle is 0.01 seconds for “light distribution area 1” and 0.01 seconds for “light distribution area 2”, and the same time, in other words, a time of an equal interval is set for both light distribution areas. Thus, the liquid crystal light distribution part 700 is controlled so that the time during which light is emitted to “light distribution area 1” and the time during which light is emitted to “light distribution area 2” are equal to each other.

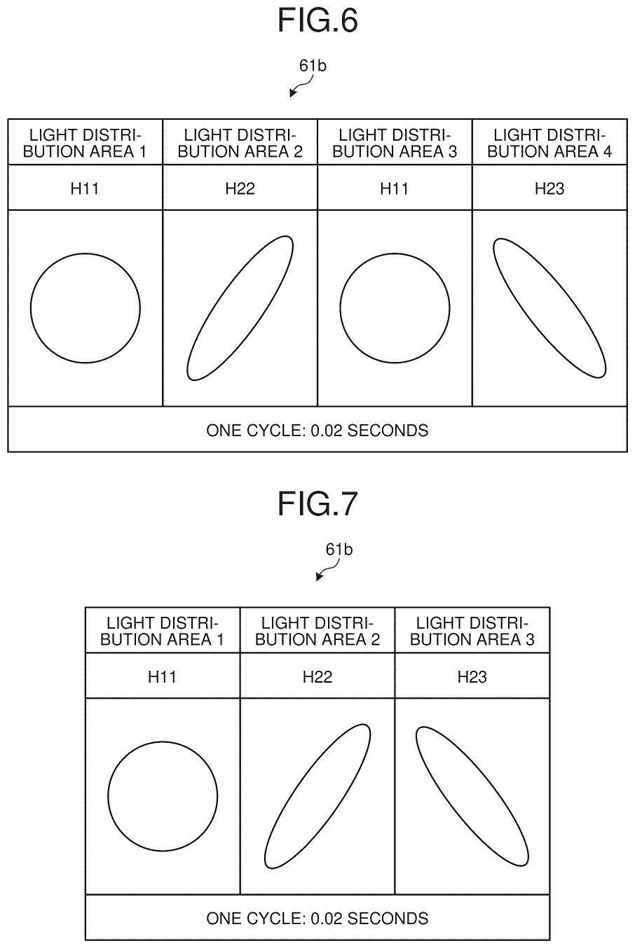

The switching cycle is set such that persons present in a room cannot perceive switching of light with eyes. For example, the switching cycle is set to be equal to or higher than 50 Hz and equal to or lower than 60 Hz. In other words, the switching cycle preferably occurs 50 times or more per second. The switching cycle is preferably equal to or higher than 100 Hz and equal to or lower than 120 Hz. This is the same for subsequent description. FIG. 6 is a conceptual diagram illustrating a second example of storage contents of the storage 61b. As illustrated in FIG. 6, the storage 61b stores light distribution areas determined by the MCU 62 among the storage contents of the storage 61a. In the present example, the light distribution area H11 is stored as “light distribution area 1”, the light distribution area H22 is stored as “light distribution area 2”, the light distribution area H11 is stored as “light distribution area 3”, and the light distribution area H23 is stored as “light distribution area 4”. Accordingly, the storage 61b stores a light distribution area pattern combining a plurality of kinds of light distribution areas. In the present example, a light distribution area pattern combining the light distribution areas H11, H22, H11, and H23 is stored.

The light distribution areas H11, H22, H11, and H23 of a light distribution area pattern as a storage content of the storage 61b are sequentially read out by the MCU 62. The MCU 62 controls the liquid crystal light distribution part 700 in a time-division manner based on the light distribution area pattern stored in the storage 61b. In other words, the MCU 62 controls the liquid crystal light distribution part 700 based on the shapes and sizes of the light distribution areas H11, H22, H11, and H23 that have been read out. Specifically, the light distribution areas H11, H22, H11, and H23 are sequentially set to the liquid crystal light distribution part 700. To the liquid crystal light distribution part 700, the MCU 62 sets the light distribution area H11 as an initial value (N=1), and then sequentially sets the light distribution areas H22 and H11. The MCU 62 also sets the light distribution area H23 as an upper limit value (N=Nmax) and then sets the light distribution area H11 as the initial value. With setting in the same manner thereafter, the light distribution areas H11, H22, H11, and H23 are repeatedly set in a time-division manner.

As illustrated in FIG. 6, the switching cycle is also stored in the storage 61b. In the present example, the switching cycle is “0.02 seconds”, corresponding to 50 Hz. In the present example, the switching cycle is 0.005 seconds for “light distribution area 1”, 0.005 seconds for “light distribution area 2”, 0.005 seconds for “light distribution area 3”, and 0.005 seconds for “light distribution area 4”, and the same time is set for all light distribution areas. Thus, the liquid crystal light distribution part 700 is controlled so that the time during which light is emitted to “light distribution area 1”, the time during which light is emitted to “light distribution area 2”, the time during which light is emitted to “light distribution area 3”, and the time during which light is emitted to “light distribution area 4” are equal to one another.

FIG. 7 is a conceptual diagram illustrating a third example of storage contents of the storage 61b. As illustrated in FIG. 7, the storage 61b stores the light distribution areas H11, H22, and H23, which are light distribution areas determined by the MCU 62 among the storage contents of the storage 61a. In the present example, the light distribution area H11 is stored as “light distribution area 1”, the light distribution area H12 is stored as “light distribution area 2”, and the light distribution area H23 is stored as “light distribution area 3”. Accordingly, the storage 61b stores a light distribution area pattern combining a plurality of kinds of light distribution areas. In the present example, a light distribution area pattern combining the light distribution areas H11, H22, and H23 is stored.

The light distribution area H11, H22, and H23 of a light distribution area pattern as a storage content of the storage 61b are sequentially read out by the MCU 62. The MCU 62 controls the liquid crystal light distribution part 700 based on the shapes and sizes of the light distribution area H11, H22, and H23 that have been read out. Specifically, the light distribution area H11, H22, and H23 are sequentially set to the liquid crystal light distribution part 700. To the liquid crystal light distribution part 700, the MCU 62 sets the light distribution area H11 as an initial value (N=1) and then sets the light distribution area H22. The MCU 62 also sets the light distribution area H23 as an upper limit value (N=Nmax) and then sets the light distribution area H11 as the initial value. With setting in the same manner thereafter, the light distribution area H11, H22, and H23 are repeatedly set in a time-division manner.

As illustrated in FIG. 7, the switching cycle is also stored in the storage 61b. In the present example, the switching cycle is “0.02 seconds”, corresponding to 50 Hz. In the present example, the switching cycle is 0.0067 seconds approximately for “light distribution area 1”, 0.0067 seconds for “light distribution area 2”, and 0.0067 seconds for “light distribution area 3”, and the same time is set for all light distribution areas. Thus, the liquid crystal light distribution part 700 is controlled so that the time during which light is emitted to “light distribution area 1”, the time during which light is emitted to “light distribution area 2”, and the time during which light is emitted to “light distribution area 3” are equal to one another.

### Light Distribution Areas Similar to Each Other in Shape

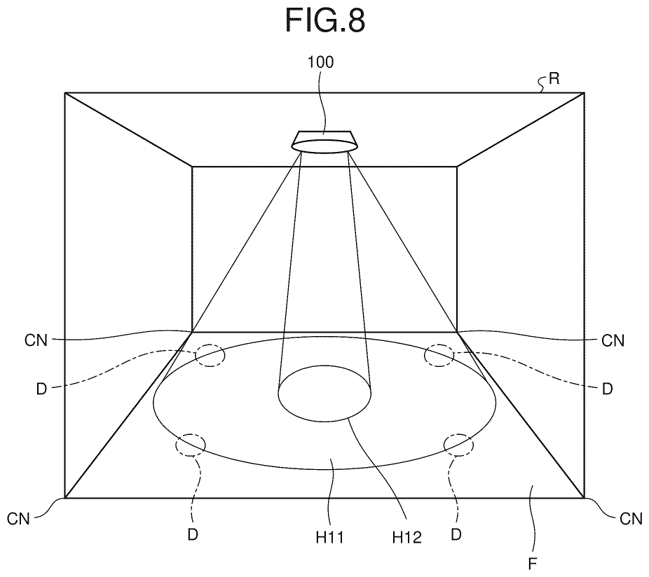

FIG. 8 is a diagram illustrating an example of setting light distribution areas similar to each other in shape with different sizes. As illustrated in FIG. 8, the illumination device 100 is installed on the ceiling of a room R. The illumination device 100 can set the light distribution areas H11 and H12 for light emitted to the floor surface F. The light distribution areas H11 and H12 are similar to each other in shape with mutually different sizes. The light distribution area H11 is relatively large and the light distribution area H12 is relatively small. The storage contents of the storage 61b described above with reference to FIG. 5 are used in the present example.

In FIG. 8, the light distribution areas H11 and H12 are similar to each other in shape. Specifically, the light distribution areas H11 and H12 are both circles and have different sizes. The circle of the light distribution area H11 and the circle of the light distribution area H12 have the same central point (not illustrated).

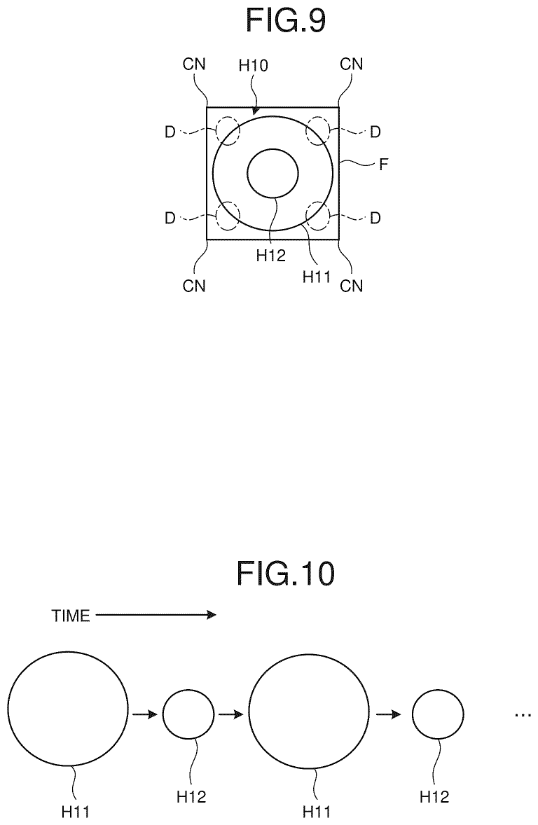

FIG. 9 is a plan view illustrating an example of the light distribution areas on the floor surface F in FIG. 8. As illustrated in FIG. 9, the light distribution area H11 is relatively large and the light distribution area H12 is relatively small. Accordingly, the larger light distribution area H11 have parts D closer to the corners CN of the floor surface F than the smaller light distribution area H12. Thus, light can be emitted to the parts D close to the corners CN of the floor surface F.

As illustrated in FIG. 9, a light distribution area H10 can be achieved by overlapping the larger light distribution area H11 and the smaller light distribution area H12. In the light distribution area H10, a part corresponding to the light distribution area H12 is included in the light distribution area H11. Thus, the part corresponding to the light distribution area H12 is constantly irradiated with light. However, a part of the light distribution area H11, which is not included in the light distribution area H12 in the light distribution area H10 is not irradiated with light for some time. Accordingly, the part corresponding to the light distribution area H12 is brighter than the other part of the light distribution area H10 than the light distribution area H12.

FIG. 10 is a diagram illustrating exemplary switching of light distribution areas by the illumination device 100 in FIGS. 8 and 9. In FIG. 10, time elapses in the direction of the arrow in the drawing. As illustrated in FIG. 10, light distribution areas are switched in the order of the light distribution areas H11, H12, H11, H12, . . . . The light distribution areas of one cycle are “light distribution areas H11 and H12”, and setting of the light distribution areas of one cycle is repeatedly performed. Specifically, the time during which light is emitted to the light distribution area H11 and the time during which light is emitted to the light distribution area H12 alternately occur by time-division control.

### Light Distribution Areas in Different Shapes

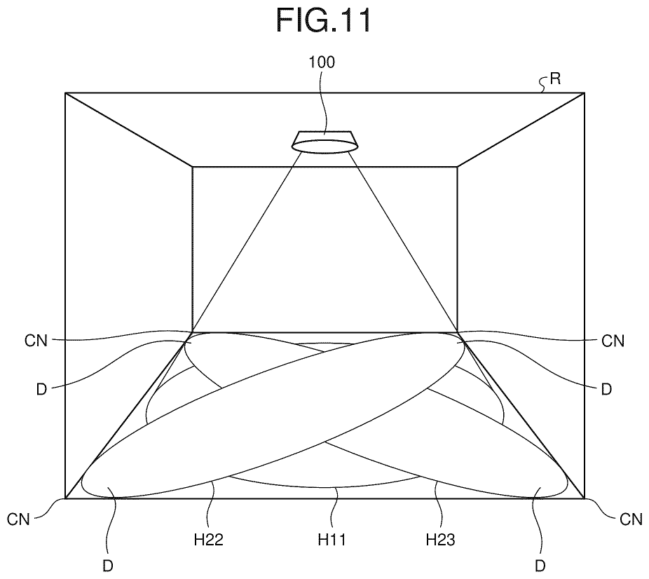

FIG. 11 is a diagram illustrating an example of setting light distribution areas in different shapes. As illustrated in FIG. 11, the illumination device 100 is installed on the ceiling of the room R. The illumination device 100 can set the light distribution areas H11, H22, and H23 for light emitted to the floor surface F. The light distribution area H11 is a circle. The light distribution area H22 and the light distribution area H23 are ellipses. The storage contents of the storage 61b described above with reference to FIG. 6 are used in the present example.

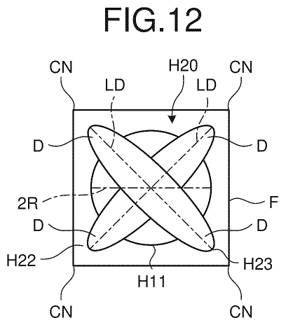

FIG. 12 is a plan view illustrating an example of light distribution areas on the floor surface F in FIG. 11. As illustrated in FIG. 12, light from the light source part 80 is changed so that the ends of a major radius LD of the ellipse of each of the light distribution areas H22 and H23 face corners CN of the floor surface F. The major radius LD of the ellipse of each of the light distribution areas H22 and H23 is longer than a diameter 2R of the circle of the light distribution area H11. Accordingly, parts D at respective end parts of the light distribution area H22 and parts D at respective end parts of the light distribution area H23 are closer to the corners CN of the floor surface F than the light distribution area H11. In other words, the light distribution areas H22 and H23 include the parts D closer to the corners CN of the floor surface F than the light distribution area H11. Thus, light can be emitted to parts close to the corners CN of the floor surface F.

As illustrated in FIG. 12, a light distribution area H20 can be achieved by overlapping the light distribution areas H11, H22, and H23 in a time-division manner. A part where the light distribution areas H11 and H22 overlap each other is brighter than a part where the light distribution area H11 does not overlap any other light distribution area. A part where the light distribution areas H11 and H23 overlap each other is brighter than a part where the light distribution area H11 does not overlap any other light distribution area. A part where the three light distribution areas H11, H22, and H23 overlap each other is brighter than the other parts.

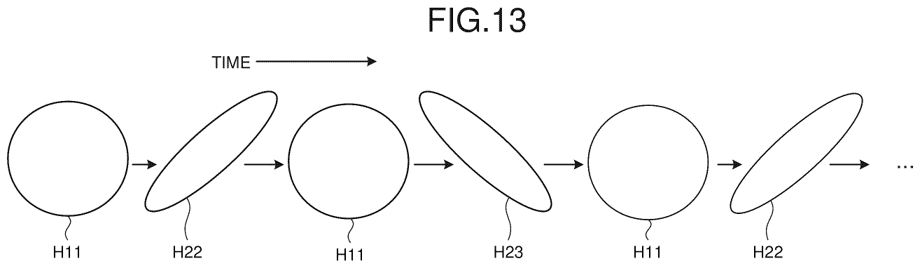

FIG. 13 is a diagram illustrating exemplary switching of light distribution areas for achieving the light distribution areas illustrated in FIGS. 11 and 12. In FIG. 13, time elapses in the direction of the arrow in the drawing. As illustrated in FIG. 13, light distribution areas are switched in the order of the light distribution areas H11, H22, H11, H23, H11, H22, . . . . The light distribution areas of one cycle are “light distribution areas H11, H22, H11, and H23”, and setting of the light distribution areas of one cycle is repeatedly performed. Specifically, the light distribution areas H11, H22, H11, and H23 are sequentially set by time-division control. In this manner, the time during which light is emitted to the circular light distribution area H11 and the time during which light is emitted to the elliptical light distribution area H22 or H23 alternately occur in the present example.

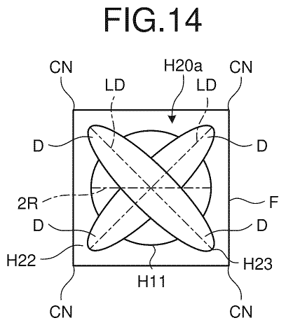

FIG. 14 is a plan view illustrating another example of light distribution areas on the floor surface F in FIG. 11. As illustrated in FIG. 14, light from the light source part 80 is changed so that the ends of a major radius LD of the ellipse of each of the light distribution areas H22 and H23 face corners CN of the floor surface F. The major radius LD of the ellipse of each of the light distribution areas H22 and H23 is longer than a diameter 2R of the circle of the light distribution area H11. Accordingly, the light distribution areas H22 and H23 include parts D closer to the corners CN of the floor surface F than the light distribution area H11. Thus, light can be emitted to parts close to the corners CN of the floor surface F. The storage contents of the storage 61b described above with reference to FIG. 7 are used in the present example.

As illustrated in FIG. 14, a light distribution area H20 can be achieved by overlapping the light distribution areas H11, H22, and H23 in a time-division manner. A part where the light distribution areas H11 and H22 overlap each other is brighter than a part where the light distribution area H11 does not overlap any other light distribution area. A part where the light distribution areas H11 and H23 overlap each other is brighter than a part where the light distribution area H11 does not overlap any other light distribution area. A part where the three light distribution areas H11, H22, and H23 overlap each other is brighter than the other parts.

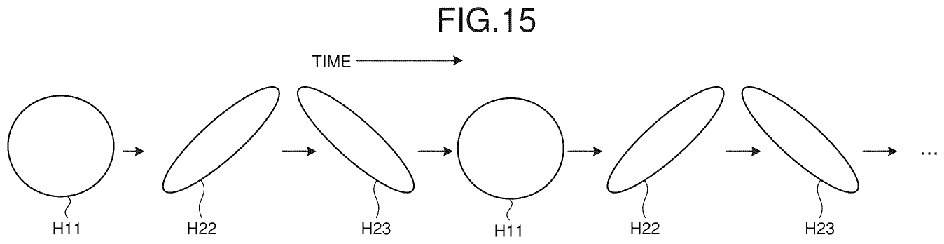

FIG. 15 is a diagram illustrating exemplary switching of light distribution areas for achieving the light distribution areas illustrated in FIG. 14. In FIG. 15, time elapses in the direction of the arrow in the drawing. As illustrated in FIG. 15, light distribution areas are switched in the order of the light distribution areas H11, H22, H23, H11, H22, and H23, . . . . The light distribution areas of one cycle are “light distribution areas H11, H22, H11, and H23”, and setting of the light distribution areas of one cycle is repeatedly performed. Specifically, the light distribution areas H11, H22, H11, and H23 are sequentially set by time-division control. In this manner, the circular light distribution area H11, the time during which light is emitted to the elliptical light distribution area H22, and the time during which light is emitted to the elliptical light distribution area H23 occur in equal proportions in the present example. Accordingly, the frequency of light being emitted to parts close to the corners CN of the floor surface F is higher than in the case of FIG. 13. As a result, with the light distribution areas illustrated in FIGS. 14 and 15, the corners CN of the floor surface F are brighter than in the case of FIG. 13.

### Second Embodiment

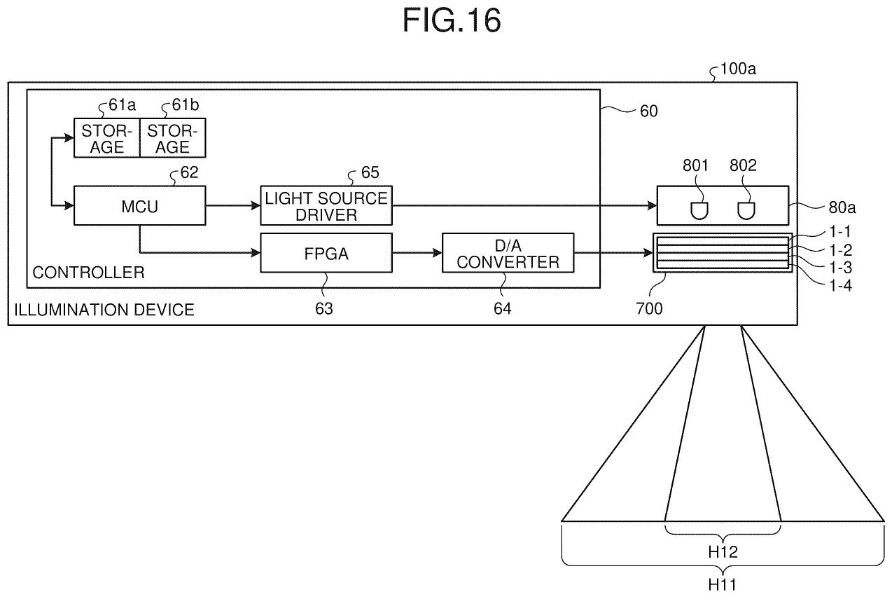

FIG. 16 is a diagram illustrating a functional configuration of an illumination device 100a according to a second embodiment of the present disclosure. The illumination device 100 includes a light source part 80a, the liquid crystal light distribution part 700, and the controller 60. The light source part 80a includes light sources 801 and 802. The other configuration of the illumination device 100a is the same as that of the illumination device 100 described above with reference to FIGS. 3 to 15.

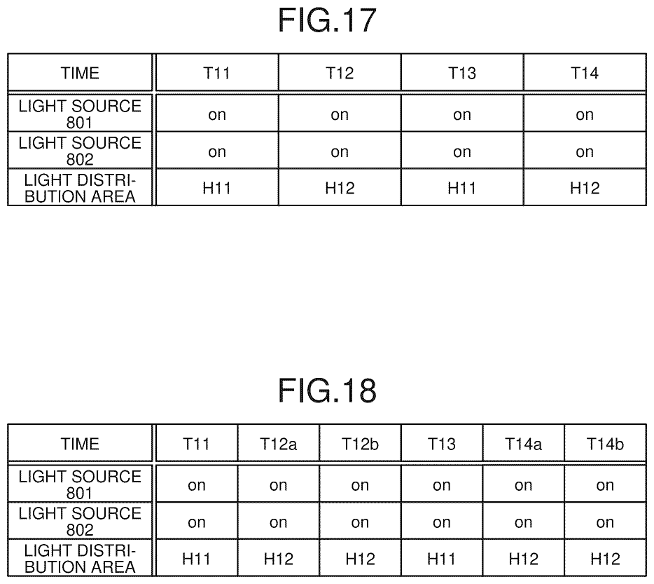

The following first describes a case where the color temperature of the light source 801 and the color temperature of the light source 802 are equal to each other. FIGS. 17 and 18 are diagrams illustrating switching of light distribution areas according to the second embodiment. FIGS. 17 and 18 are diagrams illustrating exemplary control patterns of light sources in a case where a plurality of light sources having the same color temperature are used. The shapes and sizes of light distribution areas H11 and H12 are the same as those of the light distribution areas described above with reference to FIGS. 8 to 10.

FIG. 17 illustrates a control pattern of light sources in a case where the light distribution areas H11 and H12 illustrated in FIG. 9 are irradiated with light at the same color temperature and the light distribution area H12 is irradiated with light brighter than the light distribution area H11. As illustrated in FIG. 17, the light sources 801 and 802 are turned on and the light distribution areas H11 and H12 are alternately set at times T11, T12, T13, and T14.

As for the light distribution of light from the light sources 801 and 802, in the case of FIG. 17, the light distribution area H11 is set at times T11 and T13 and the light distribution area H12 is set at times T12 and T14.

As for the irradiation plane of light, in the case of FIG. 17, an outer part of the light distribution area H11, which does not overlap the light distribution area H12 is irradiated with light at times T11 and T13. An inner part where the light distribution areas H11 and H12 overlap each other is irradiated with light at all times T11 to T14.

FIG. 18 illustrates a control pattern of light sources in a case where the light distribution area H12 is even brighter under the condition of FIG. 17. As illustrated in FIG. 18, the light sources 801 and 802 as turned on at times T11, T12a, T12b, T13, T14a, and T14b. The light distribution area H11 is set once and then the light distribution area H12 is set twice, and the same setting is repeated thereafter.

As for the light distribution of light from the light sources 801 and 802, in the case of FIG. 18, the light distribution area H11 is set at times T11 and T13 and the light distribution area H12 is set at times T12a, T12b, T14a, and T14b. Accordingly, the time during which the light distribution area H12 is set is longer than the time during which the light distribution area H11 is set.

As for the irradiation plane of light, in the case of FIG. 18, an outer part of the light distribution area H11, which does not overlap the light distribution area H12 is irradiated with light at times T11 and T14. An inner part where the light distribution areas H11 and H12 overlap each other is irradiated with light at all times T11, T12a, T12b, T13, T14a, and T14b.

In the cases illustrated in FIGS. 17 and 18, the light sources are not turned off at any of the times, and accordingly, the overall luminance of the light distribution areas H11 and H12 is constant.

### Third Embodiment

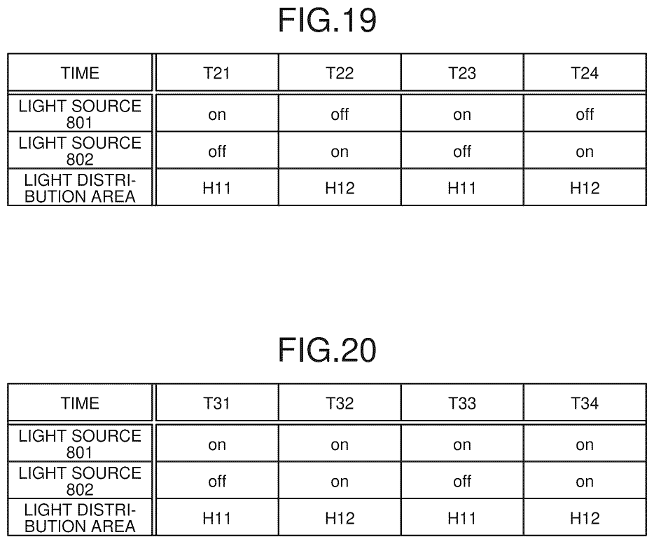

The following describes a case where the color temperature of the light source 801 and the color temperature of the light source 802 are different from each other. FIGS. 19 and 20 are diagrams illustrating switching of light distribution areas according to a third embodiment. FIGS. 19 and 20 are diagrams illustrating control patterns of light sources in a case where a plurality of light sources having color temperatures different from each other are used. Specifically, the light source 801 emits light of a predetermined color temperature when on, and the light source 802 emits light of a color temperature different from the color temperature of light from the light source 801 when on. The shapes and sizes of the light distribution areas H11 and H12 are the same as those of the light distribution areas described above with reference to FIGS. 8 to 10.

FIG. 19 is a control pattern of light sources in a case where the color temperature of light emitted to the light distribution area H11 illustrated in FIG. 9 and the color temperature of light emitted to the light distribution area H12 are different from each other. As for the light distribution of light from the light sources 801 and 802, in the case of FIG. 19, the light distribution area H11 is set at times T21 and T23 when the light source 801 is turned on, and the light distribution area H12 is set at times T22 and T24 when the light source 802 is turned on. In this manner, the light sources 801 and 802 are turned on or off so that the time during which light is emitted from the light source 801 and the time during which light is emitted from the light source 802 do not overlap each other. In the case of FIG. 19, light emitted from the light source 801 is set to any one of the light distribution areas H11 and H12, and light emitted from the light source 802 is set to the other of the light distribution areas H11 and H12.

As for the irradiation plane of light, in the case of FIG. 19, an outer part of the light distribution area H11, which does not overlap the light distribution area H12 is irradiated with light from the light source 801 at times T21 and T23. An inner part where the light distribution areas H11 and H12 overlap each other is irradiated with light from the light source 801 at times T21 and T23 and from the light source 802 at times T22 and T24.

FIG. 20 is another control pattern of the light sources in a case where the color temperature of light emitted to the light distribution area H11 illustrated in FIG. 9 and the color temperature of light emitted to the light distribution area H12 are different from each other. As for the light distribution of light from the light sources 801 and 802, in the case of FIG. 20, the light distribution areas H11 and H12 are alternately set at times T31 to T34 when the light source 801 is turned on, and the light distribution area H12 is set at times T32 and T34 when the light source 802 is turned on. In this manner, the light sources 801 and 802 are turned on or off so that at least part of the time during which light is emitted from the light source 801 overlaps the time during which light is emitted from the light source 802.

As for the irradiation plane of light, in the case of FIG. 20, an outer part of the light distribution area H11, which does not overlap the light distribution area H12 is irradiated with light from the light source 801 at times T31 and T33. An inner part where the light distribution areas H11 and H12 overlap each other is irradiated with light from the light source 801 at times T31, T32, T33, and T34 and from the light source 802 at times T32 and T34.

In the case of FIG. 20, luminance at the above-described inner part is higher than at the above-described outer part, as compared to the case of FIG. 19. However, in the case of FIG. 20, the color temperature difference is smaller than in the case of FIG. 19.

### Fourth Embodiment

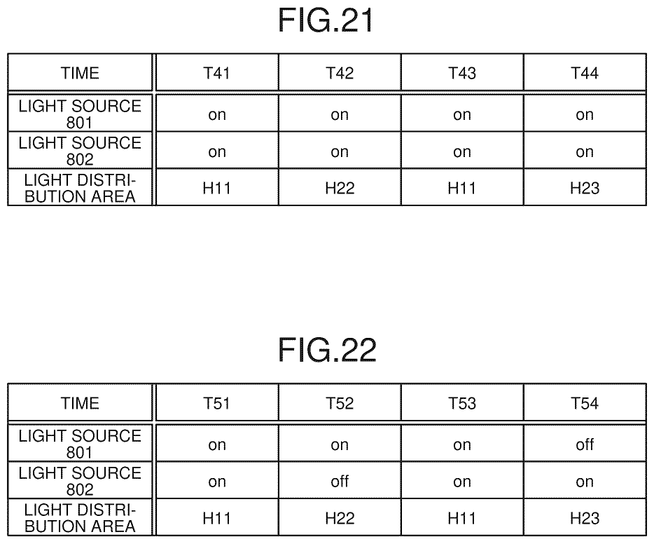

FIG. 21 is a diagram illustrating switching of light distribution areas according to a fourth embodiment. FIG. 21 is a diagram illustrating a control pattern in a case where the light distribution areas H11, H22, and H23 illustrated in FIG. 12 are irradiated with light of the same color temperature. As for the light distribution of light from the light sources 801 and 802, in the case of FIG. 21, the light distribution area H11 is set at times T41 and T43 when the light sources 801 and 802 are turned on, the light distribution area H22 is set at time T42 when the light sources 801 and 802 are turned on, and the light distribution area H23 is set at time T44 when the light sources 801 and 802 are turned on. In this manner, the light sources 801 and 802 are turned on or off so that at least part of the time during which light is emitted from the light source 801 overlaps the time during which light is emitted from the light source 802.

As for the irradiation plane of light, in the case of FIG. 21, the light distribution area H11 includes a part including the light distribution area H22 and a part including the light distribution area H23, and these parts are irradiated with light at all times T41 to T44.

Accordingly, if the time of light emission for the light distribution areas H2 and H3 is longer than the time of light emission for the light distribution area H11, uneven brightness occurs in the irradiation plane of light to the light distribution area H11. To make the luminance uniform throughout the room, the time of light emission for the light distribution area H11 is set to be longer than the time of light emission for the light distribution areas H22 and H23 so that uneven brightness cannot be recognized.

### Fifth Embodiment

FIG. 22 is a diagram illustrating switching of light distribution areas according to a fifth embodiment. FIG. 22 is a diagram illustrating a control pattern in a case where the light distribution areas H22 and H23 illustrated in FIG. 12 are irradiated with light of different color temperatures and the light distribution area H11 is irradiated with light of the different color temperatures. As for the light distribution of light from the light sources 801 and 802, in the case of FIG. 22, the light distribution area H11 is set at times T51 and T53 when the light sources 801 and 802 are both turned on, the light distribution area H22 is set at time T52 when only the light source 801 is turned on, and the light distribution area H23 is set at time T54 when only the light source 802 is turned on. In this manner, the light sources 801 and 802 are turned on or off so that at least part of the time during which light is emitted from the light source 801 overlaps the time during which light is emitted from the light source 802.

As for the irradiation plane of light, in the case of FIG. 22, the light distribution area H11 includes a part including the light distribution area H22 and a part including the light distribution area H23, and these parts are irradiated with light at all times T41 to T44. The parts D at the ends of the light distribution area H22 (refer to FIG. 12) are irradiated with light at time T52 when only the light source 801 is turned on. The parts D at the ends of the light distribution area H23 (refer to FIG. 12) are irradiated with light at time T54 when only the light source 802 is turned on.

In a part where the light distribution areas H11, H22, and H23 overlap each other, the ratio of light from the light source 801 to light from the light source 802 differs depending on location, resulting in color change. To make the color temperature uniform throughout the room, the time of emission for the light distribution area H11 is set to be longer than the time of emission for the light distribution areas H22 and H23 so that uneven color cannot be recognized.

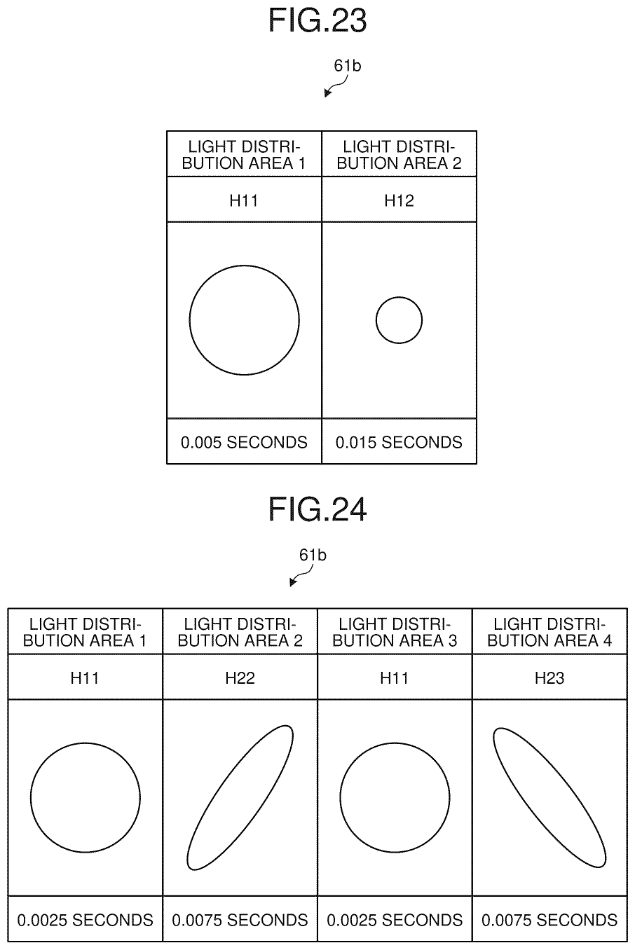

The above describes the cases where the same time is set to light distribution areas in the switching cycle, but different times may be set to light distribution areas. FIGS. 23 to 25 are diagrams illustrating examples of storage contents of the storage 61b in a case where different times are set to light distribution areas.

In FIG. 23, 0.005 seconds is for “light distribution area H11” as light distribution area 1, and 0.015 seconds for “light distribution area H12” as light distribution area 2. Accordingly, the liquid crystal light distribution part 700 is controlled in a time-division manner so that the time during which light is emitted to the light distribution area H11 is different from the time during which light is emitted to the light distribution area H12. When the switching cycle is set in this manner, more light can be emitted near the center of the floor surface F.

In FIG. 24, 0.0025 seconds is for “light distribution area H11” as light distribution area 1, 0.0075 seconds is for “light distribution area H22” as light distribution area 2, 0.0025 seconds is for “light distribution area H11” as light distribution area 3, and 0.0075 seconds is for “light distribution area H23” as light distribution area 4. Accordingly, the liquid crystal light distribution part 700 is controlled in a time-division manner so that the time during which light is emitted to the light distribution area H11 is different from the time during which light is emitted to the light distribution areas H22 and H23. When the switching cycle is set in this manner, light can be emitted to the corners CN of the floor surface F as well.

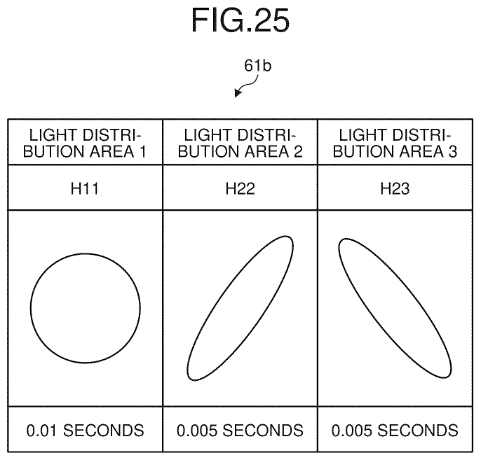

In FIG. 25, 0.01 seconds is for “light distribution area H11” as light distribution area 1, 0.005 seconds is for “light distribution area H22” as light distribution area 2, and 0.005 seconds is for “light distribution area H23” as light distribution area 3. Accordingly, the liquid crystal light distribution part 700 is controlled in a time-division manner so that the time during which light is emitted to the light distribution area H11 is different from the time during which light is emitted to the light distribution areas H22 and H23. When the switching cycle is set in this manner, light can be emitted in a well-balanced manner near the center of the floor surface F and the corners CN.

### Processing by Controller

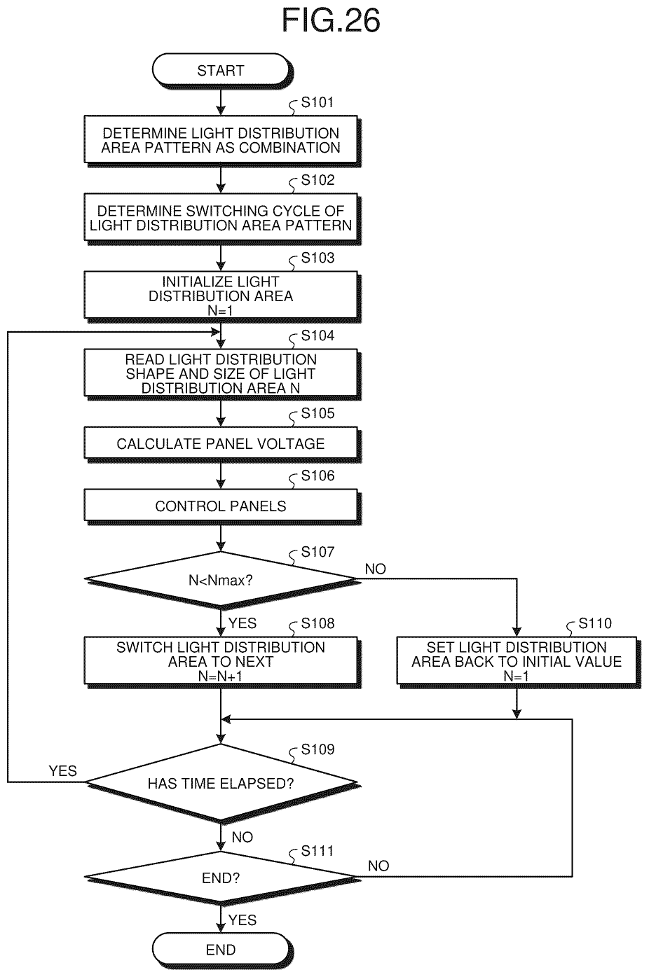

FIG. 26 is a flowchart illustrating an example of processing by the controller 60 of the illumination device 100. FIG. 26 mainly illustrates the contents of processing by the MCU 62.

In FIG. 26, the MCU 62 reads out light distribution areas stored in the storage 61a in advance and determines a light distribution area pattern as a combination thereof (step S101).

In addition, the switching cycle of the light distribution area pattern is determined (step S102). Data of the light distribution area pattern as the combination and data of the switching cycle are stored in the storage 61b by the MCU 62. Thereafter, the MCU 62 initializes a light distribution area (step S103). Specifically, a light distribution area N is set to an initial value (N=1) (N is an integer equal to or larger than one). The processing at steps S101 to S103 is performed at installation of the illumination device 100.

After installation of the illumination device 100 is completed, processing at step S104 and later is performed by the MCU 62.

First, the MCU 62 reads out the light distribution shape and size of the light distribution area N from the storage 61b (step S104). The MCU 62 calculates voltage (in other words, panel voltage) to be applied to the liquid crystal light distribution panels based on the light distribution shape and size of the light distribution area N (step S105). The MCU 62 controls the liquid crystal light distribution panels by applying the panel voltage (step S106).

Subsequently, the MCU 62 determines whether the light distribution area N has reached an upper limit value (N=Nmax) (step S107). In a case where the light distribution area N has not reached the upper limit value (N=Nmax) as a result of the determination at step S107 (Yes at step S107), the light distribution area is switched to the next one (step S108). Specifically, N is set to N+1. Subsequently, it is determined whether a certain amount of time has elapsed (step S109). In a case where the certain amount of time has elapsed as a result of the determination at step S109 (Yes at step S109), the process returns to step S104 to continue the processing.

In a case where the light distribution area N has reached the upper limit value (Nmax) as a result of the determination at step S107 (No at step S107), the light distribution area is set back to the initial value (step S110). Specifically, N is set to 1. Subsequently, the MCU 62 determines whether the certain amount of time has elapsed (step S109).

In a case where the certain amount of time has not elapsed as a result of the determination at step S109 (No at step S109), it is determined whether to end the processing (step S111). In a case where the processing is not to be ended as a result of the determination at step S111 (No at step S111), the process returns to step S109 to continue the processing. Accordingly, the same light distribution area is maintained until the certain amount of time elapses. In other words, the light distribution shape and size are maintained until the certain amount of time elapses.

In a case where the processing is to be ended as a result of the determination at step S111 (Yes at step S111), the processing by the controller 60 is ended.

As described above, the light distribution area of light emitted from a light source part is controlled by using a liquid crystal light distribution part to switch a plurality of light distribution areas by time-division control, thereby overlapping irradiation areas of light, and moreover, emitting light to the corners of the floor of a room. The brightness of each irradiation area can be adjusted by changing the ratio of time division of each light distribution area.

### Liquid Crystal Light Distribution Panel

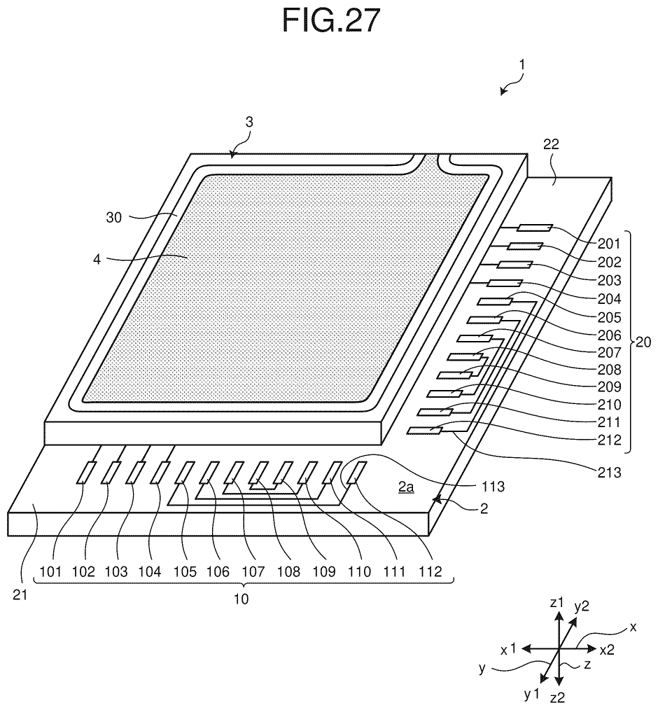

The liquid crystal light distribution panels 1-1 to 1-4 included in the liquid crystal light distribution part 700 will be described below with reference to FIGS. 27 to 31.

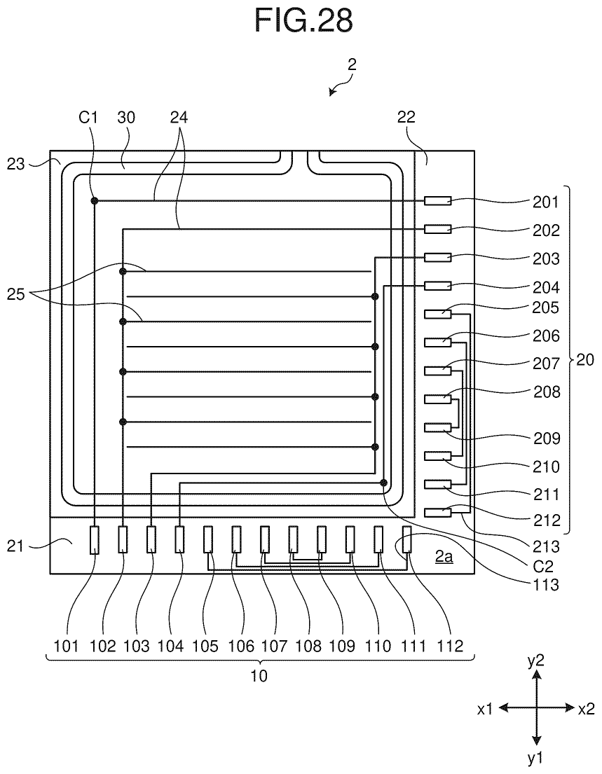

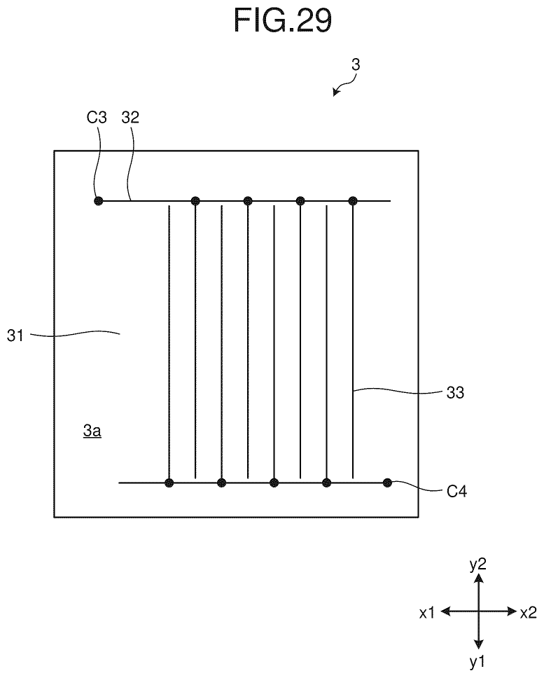

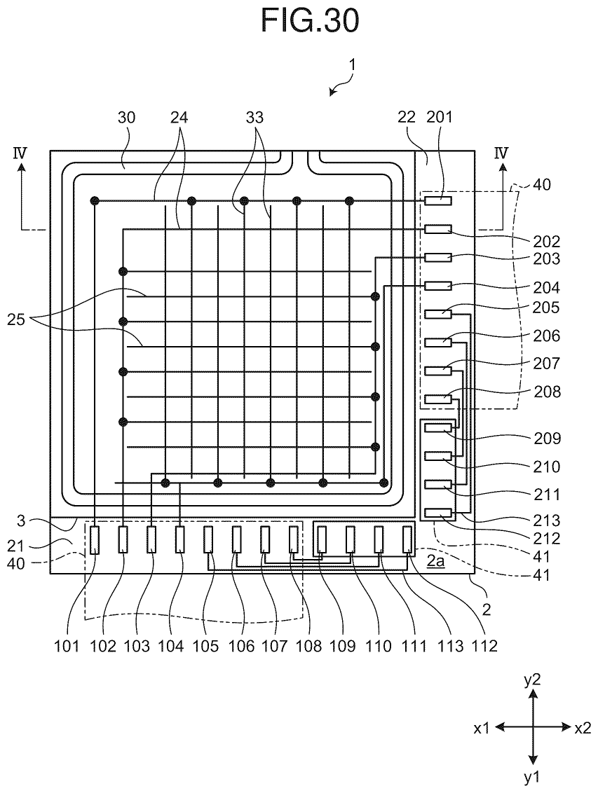

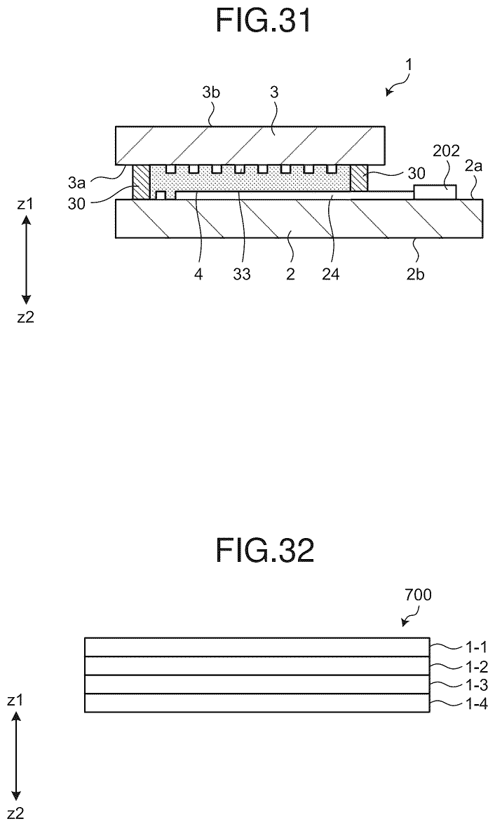

FIG. 27 is a perspective view of a liquid crystal light distribution panel according to an embodiment. FIG. 28 is a plan view illustrating wiring of an array substrate of the liquid crystal light distribution panel according to the embodiment when viewed from above. FIG. 29 is a plan view illustrating wiring of a counter substrate of the liquid crystal light distribution panel according to the embodiment when viewed from above. FIG. 30 is a plan view illustrating wiring of the liquid crystal light distribution panel according to the embodiment when viewed from above. FIG. 31 is a sectional view taken along line IV-IV in FIG. 30. Note that, in an xyz coordinate system illustrated in FIGS. 27 to 30, a direction along an x1 direction and an x2 direction is referred to as an x direction. The x1 direction is opposite to the x2 direction. A direction along a y1 direction and a y2 direction is referred to as a y direction. The y1 direction is opposite to the y2 direction. A direction along a z1 direction and a z2 direction is referred to as a z direction. The z1 direction is opposite the z2 direction. The x direction is orthogonal to the y direction. A plane including the x direction and the y direction is orthogonal to the z direction.

As illustrated in FIG. 27, each liquid crystal light distribution panel 1 includes an array substrate 2, a counter substrate 3, a liquid crystal layer 4, and a seal material 30.

As illustrated in FIGS. 27 and 30, the array substrate (first substrate) 2 is larger than the counter substrate (second substrate) 3. In other words, the area of the counter substrate (second substrate) 3 is smaller than the area of the array substrate (first substrate) 2. The array substrate 2 includes a transparent glass 23 (refer to FIG. 28). The counter substrate 3 includes a transparent glass 31 (refer to FIG. 29). In the embodiment, the array substrate 2 and the counter substrate 3 have square shapes in a plan view from above, but the shape of each substrate according to the present disclosure is not limited to a square shape. A first terminal group area 21 and a second terminal group area 22 are provided on a front surface 2a of the array substrate 2. The first terminal group area 21 is positioned at an end part of the front surface 2a of the array substrate 2 on the y1 side. The second terminal group area 22 is positioned at an end part of the front surface 2a of the array substrate 2 on the x2 side. The first terminal group area 21 and the second terminal group area 22 have L shapes when viewed from above. A first terminal group 10 is disposed in the first terminal group area 21, and a second terminal group 20 is disposed in the second terminal group area 22. Note that since the area of the counter substrate 3 is smaller than the area of the array substrate 2, the first terminal group 10 and the second terminal group 20 are exposed. The first terminal group 10 and the second terminal group 20 are also simply referred to as terminal portions.

As illustrated in FIGS. 27 and 30, the first terminal group 10 includes a first terminal 101, a second terminal 102, a third terminal 103, a fourth terminal 104, a first pad 105, a second pad 106, a third pad 107, a fourth pad 108, a fifth pad 109, a sixth pad 110, a seventh pad 111, and an eighth pad 112. The first terminal 101, the second terminal 102, the third terminal 103, the fourth terminal 104, the first pad 105, the second pad 106, the third pad 107, the fourth pad 108, the fifth pad 109, the sixth pad 110, the seventh pad 111, and the eighth pad 112 are sequentially arranged in a right-left direction from the x1 side toward the x2 side. The first pad 105 and the eighth pad 112 are electrically coupled to each other through a lead line 113. The second pad 106 and the seventh pad 111 are electrically coupled to each other through a lead line 113. The third pad 107 and the sixth pad 110 are electrically coupled to each other through a lead line 113. The fourth pad 108 and the fifth pad 109 are electrically coupled to each other through a lead line 113.

As illustrated in FIGS. 27 and 30, the second terminal group 20 includes a fifth terminal 201, a sixth terminal 202, a seventh terminal 203, an eighth terminal 204, a ninth pad 205, a tenth pad 206, an eleventh pad 207, a twelfth pad 208, a thirteenth pad 209, a fourteenth pad 210, a fifteenth pad 211, and a sixteenth pad 212. The fifth terminal 201, the sixth terminal 202, the seventh terminal 203, the eighth terminal 204, the ninth pad 205, the tenth pad 206, the eleventh pad 207, the twelfth pad 208, the thirteenth pad 209, the fourteenth pad 210, the fifteenth pad 211, and the sixteenth pad 212 are sequentially arranged in a front-back direction from the y2 side toward the y1 side. The ninth pad 205 and the sixteenth pad 212 are electrically coupled to each other through a lead line 213. The tenth pad 206 and the fifteenth pad 211 are electrically coupled to each other through a lead line 213. The eleventh pad 207 and the fourteenth pad 210 are electrically coupled to each other through a lead line 213. The twelfth pad 208 and the thirteenth pad 209 are electrically coupled to each other through a lead line 213.

Note that, as illustrated in FIG. 27, the counter substrate 3 is disposed on an upper side (z1 side) relative to the array substrate 2. The seal material 30 and the liquid crystal layer 4 are provided between the counter substrate 3 and the array substrate 2. The seal material 30 is provided in an annular shape along the outer periphery of the counter substrate 3 and the inside of the seal material 30 is filled with the liquid crystal layer 4. Note that a region in which the liquid crystal layer 4 is provided is an active region, the outside of the liquid crystal layer 4 is a frame region, and the first terminal group area 21 and the second terminal group area 22 are terminal regions.

Wiring of the array substrate 2 and the counter substrate 3 will be described below. Note that, as illustrated in FIG. 31, wiring is provided on a front surface among the front and back surfaces of each substrate. In other words, a surface on which wiring is provided is referred to as a front surface, and a surface opposite the front surface is referred to as a back surface. Specifically, as illustrated in FIG. 31, wiring is provided on the front surface 2a of the upper side among the front surface 2a and a back surface 2b of the array substrate 2, and wiring is provided on the front surface 3a of the lower side among a front surface 3a and a back surface 3b of the counter substrate 3. In this manner, the front surface 2a of the array substrate 2 and the front surface 3a of the counter substrate 3 are disposed facing each other with the liquid crystal layer 4 interposed therebetween.

As illustrated in FIG. 28, wires 24 and first electrodes 25 are provided on the front surface 2a of the transparent glass 23 of the array substrate 2. Specifically, the first terminal 101 and the fifth terminal 201 are electrically coupled to each other through a wire 24. The second terminal 102 and the sixth terminal 202 are electrically coupled to each other through a wire 24. The third terminal 103 and the seventh terminal 203 are electrically coupled to each other through a wire 24. The fourth terminal 104 and the eighth terminal 204 are electrically coupled to each other through a wire 24. A plurality of first electrodes 25 are coupled to the wire 24 coupling the second terminal 102 and the sixth terminal 202. A plurality of first electrodes 25 are coupled to the wire 24 coupling the third terminal 103 and the seventh terminal 203. Note that couplers C1 and C2 are provided on the wires 24.

As illustrated in FIG. 29, wires 32 and second electrodes 33 are provided on the front surface 3a of the counter substrate 3. Specifically, the wires 32 are provided on the y1 side and the y2 side, respectively. The wires 32 extend in the x direction. The second electrodes 33 are electrically coupled to the wires 32. The second electrodes 33 extend in the y direction. Note that couplers C3 and C4 are provided on the wires 32. In the example illustrated in FIGS. 28 to 30, the number of first electrodes 25 and the number of second electrodes 33 are eight, but these numbers are schematic and are not necessarily the actual numbers of first electrodes 25 and second electrodes 33. The number of first electrodes 25 and the number of second electrodes 33 only need to be equal to or larger than two and thus may be equal to or larger than nine.

As illustrated in FIGS. 30 and 31, the counter substrate 3 is disposed at an interval on the upper side relative to the array substrate 2. The liquid crystal layer 4 is filled between the array substrate 2 and the counter substrate 3. The coupler C1 of the array substrate 2 and the coupler C3 of the counter substrate 3 are electrically coupled to each other through a conductive pillar (not illustrated). The coupler C2 of the array substrate 2 and the coupler C4 of the counter substrate 3 are electrically coupled to each other through a conductive pillar (not illustrated).

As illustrated in FIG. 30, the first terminal 101, the second terminal 102, the third terminal 103, the fourth terminal 104, the first pad 105, the second pad 106, the third pad 107, and the fourth pad 108 can be electrically coupled to flexible printed circuits (FPC) 40 illustrated with dashed and double-dotted lines. For example, the liquid crystal light distribution panels 1-1 to 1-4 are each coupled to the D/A converter 64 through the individually provided FPC 40.

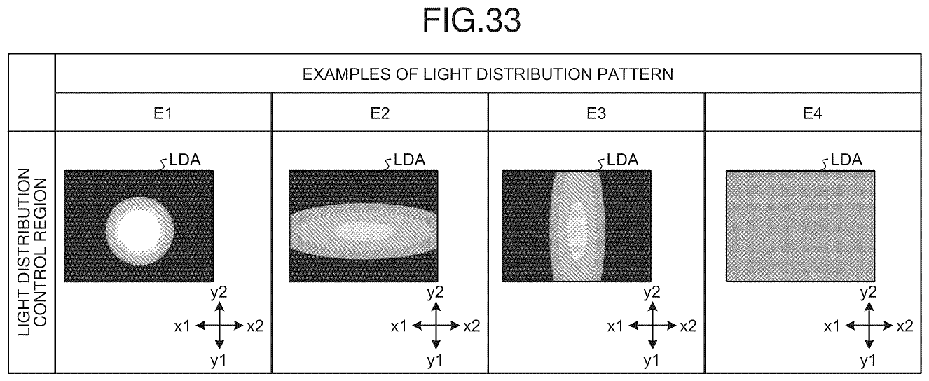

FIG. 32 is a schematic diagram illustrating the configuration of the liquid crystal light distribution part 700. As illustrated in FIG. 32, the liquid crystal light distribution part 700 includes, for example, four liquid crystal light distribution panels 1-1 to 1-4 stacked in the z direction. The four liquid crystal light distribution panels 1-1 to 1-4 are the liquid crystal light distribution panels 1-1 to 1-4 described above with reference to FIGS. 27 to 31. The four liquid crystal light distribution panels 1-1 to 1-4 are stacked so that the liquid crystal layers 4 thereof overlap each other and disposition of the first electrodes 25 and the second electrodes 33 included in each light modulation panel overlaps those of the others at a plan viewpoint. A plan viewpoint is the viewpoint of a front view of a plane including the x direction and the y direction. A region in which the first electrodes 25 and the second electrodes 33 are disposed functions as a light distribution control region LDA illustrated in FIG. 33 and the like to be described later.

FIG. 33 is a schematic diagram illustrating an example of light distribution control by the light distribution control region LDA. As described above, the light distribution control region LDA is a region in which the plurality of first electrodes 25 and the plurality of second electrodes 33 are disposed at a plan viewpoint. In other words, the light distribution control region LDA includes a plurality of electrodes extending in the x direction and arranged in the y direction and a plurality of electrodes extending in the y direction and arranged in the x direction. The electrodes extending in the x direction and arranged in the y direction are, for example, the first electrodes 25. The electrodes extending in the y direction and arranged in the x direction are, for example, the second electrodes 33.

Since the liquid crystal light distribution part 700 includes the four liquid crystal light distribution panels 1-1 to 1-4 overlapping each other in the z direction, the electrodes extending in the x direction and arranged in the y direction and the electrodes extending in the y direction and arranged in the x direction are quadruplicated in the z direction. The light distribution control region LDA can control the transmission area and transmission degree of light traveling from one surface side of the liquid crystal light distribution part 700 toward the other surface side as in Examples E1, E2, E3, and E4 as “exemplary light distribution patterns” illustrated in FIG. 33 by controlling the potential of each of the electrodes extending in the x direction and arranged in the y direction and the electrodes extending in the y direction and arranged in the x direction of the four liquid crystal light distribution panels 1-1 to 1-4 included in the liquid crystal light distribution part 700.

Note that, in the following description, equal potential is applied to electrodes overlapping each other at a plan viewpoint. Example E1 in FIG. 33 is a schematic diagram illustrating the state of the light distribution control region LDA when viewed at a plan viewpoint from a side opposite a light source (for example, a light source 800) in a case where the potentials of the electrodes extending in the x direction and arranged in the y direction and the electrodes extending in the y direction and arranged in the x direction are all 0 volt (V). In Example E1, light from the light source transmits through the light distribution control region LDA with almost no change.

Example E2 is a schematic diagram illustrating the state of the light distribution control region LDA when viewed at a plan viewpoint from a side opposite a light source (for example, a light source 800) in a case where the potentials of the plurality of electrodes extending in the x direction and arranged in the y direction are 0 volt (V), and the potentials of the plurality of electrodes extending in the y direction and arranged in the x direction exceed 0 volt (V). Example E2 illustrates the state of the light distribution control region LDA when controlling light distribution so that, when light spread in the x direction and light spread in the y direction are compared, light from the light source relatively largely spreads in the x direction but does not much spread in the y direction.

Example E3 is a schematic diagram illustrating the state of the light distribution control region LDA when viewed at a plan viewpoint from a side opposite a light source (for example, a light source 800) in a case where the potentials of the plurality of electrodes extending in the x direction and arranged in the y direction exceed 0 volt (V), and the potentials of the plurality of electrodes extending in the y direction and arranged in the x direction are 0 volt (V). Example E3 illustrates the state of the light distribution control region LDA when controlling light distribution so that, when light spread in the x direction and light spread in the y direction are compared, light from the light source relatively largely spreads in the y direction but does not much spread in the x direction.

Example E4 is a schematic diagram illustrating the state of the light distribution control region LDA when viewed at a plan viewpoint from a side opposite a light source (for example, a light source 800) in a case where the potentials of the electrodes extending in the x direction and arranged in the y direction and the electrodes extending in the y direction and arranged in the x direction all exceed 0 volt (V). Example E4 illustrates the state of the light distribution control region LDA being entirely dark when viewed from the side opposite the light source with the light distribution control region LDA interposed therebetween because light from the light source is significantly interrupted by the light distribution control region LDA.

Note that the light distribution control region LDA only needs to include, at a plan viewpoint, two or more electrodes extending in the x direction and arranged in the y direction and two or more electrodes extending in the y direction and arranged in the x direction. A first condition is such that one light distribution control region LDA includes m electrodes extending in the x direction and arranged in the y direction and n electrodes extending in the y direction and arranged in the x direction. A second condition is such that the number of electrodes (for example, first electrodes 25) extending in the x direction and arranged in the y direction is m×p and the number of electrodes extending in the y direction and arranged in the x direction (for example, second electrodes 33) is n×q in each of the four liquid crystal light distribution panels 1-1 to 1-4. With the first and second conditions as a premise, p light distribution control regions LDA in the x direction and q light distribution control regions LDA in the y direction can be set in a matrix of rows and columns in the liquid crystal light distribution part 700. The numbers m, n, p, and q are natural numbers of two or more. Alternatively, the entire active region (region in which the liquid crystal layer 4 is provided) included in one liquid crystal light distribution panel at a plan viewpoint may be one light distribution control region LDA.

Examples E1, E2, E3, and E4 in FIG. 33 particularly illustrate difference in the shape of the light distribution area at a plan viewpoint by potential control. As described above with reference to FIGS. 30 and 31, the shape and size of the light transmission area can be more flexibly controlled because of the relation between potential provided to the first electrodes 25 and potential provided to the second electrodes 33. With this control, the shape and size of emitted light can be changed.

With respect to the claims, the present disclosure may take the following forms.

What is claimed is:

1. An illumination device comprising:
a light source part configured to emit light to a floor surface of a room;
a light distribution area setter configured to set a light distribution area of light from the light source part to a first light distribution area or a second light distribution area different from the first light distribution area; and
a controller configured to control the light distribution area setter so that light is emitted to the first light distribution area and the second light distribution area in a time-division manner, wherein
the second light distribution area set by the light distribution area setter includes a part closer to a corner of the floor surface than the first light distribution area.

2. The illumination device according to claim 1, wherein
the light distribution area setter includes a liquid crystal light distribution panel for p-wave polarization and a liquid crystal light distribution panel for s-wave polarization,
the liquid crystal light distribution panel for p-wave polarization and the liquid crystal light distribution panel for s-wave polarization are stacked on each other,
a signal based on light to be emitted is provided to the liquid crystal light distribution panel for p-wave polarization and the light adjustment panel for s-wave polarization,
light emitted from the light source part is emitted through the liquid crystal light distribution panel for p-wave polarization and the liquid crystal light distribution panel for s-wave polarization, and thereby,
the light distribution area of light from the light source part is switched to the first light distribution area or the second light distribution area.

3. The illumination device according to claim 1, wherein the first light distribution area is similar to the second light distribution area in shape with a different size.

4. The illumination device according to claim 1, wherein the first light distribution area is a circle and the second light distribution area is an ellipse.

5. The illumination device according to claim 4, wherein the major radius of the ellipse of the second light distribution area is longer than the diameter of the circle of the first light distribution area.

6. The illumination device according to claim 4, wherein the light distribution area setter changes light from the light source part so that the ends of the major radius of the ellipse of the second light distribution area face corners of the floor surface.

7. The illumination device according to claim 1, wherein the controller controls the light distribution area setter so that a time during which light is emitted to the first light distribution area is equal to a time during which light is emitted to the second light distribution area.

8. The illumination device according to claim 1, wherein the controller controls the light distribution area setter so that a time during which light is emitted to the first light distribution area is different from a time during which light is emitted to the second light distribution area.

9. The illumination device according to claim 1, wherein
the light source part includes a first light source and a second light source, the first light source being configured to emit light of a predetermined color temperature when on, the second light source being configured to emit light of a color temperature different from the color temperature of light from the first light source when on, and
the controller turns the first light source and the second light source on or off so that at least part of a time during which light from the first light source is emitted overlaps a time during which light from the second light source is emitted.

10. The illumination device according to claim 1, wherein
the light source part includes a first light source and a second light source, the first light source being configured to emit light of a predetermined color temperature when on, the second light source being configured to emit light of a color temperature different from the color temperature of light from the first light source when on, and
the controller turns the first light source and the second light source on or off so that a time during which light is emitted from the first light source and a time during which light is emitted from the second light source do not overlap each other.

11. The illumination device according to claim 9, wherein the controller controls the light distribution area setter to set light emitted from the first light source to any one of the first light distribution area and the second light distribution area and light emitted from the second light source to the other of the first light distribution area and the second light distribution area.

12. The illumination device according to claim 1, wherein one cycle of control by the controller occurs 50 times or more per second.

13. The illumination device according to claim 1, further comprising: a first storage configured to store light distribution area data corresponding to a plurality of kinds of light distribution areas including the first light distribution area and the second light distribution area; and a second storage configured to store a light distribution area pattern combining the kinds of light distribution areas, wherein
the controller combines the kinds of light distribution areas stored in the first storage, stores the combination in the second storage as the light distribution area pattern, and controls the light distribution area setter based on the light distribution area pattern stored in the second storage.
